(19) United States
(12) Patent Application Publication
(10) Pub. No.: US 2009/0220658 A1
(43) Pub. Date: Sep. 3, 2009

(54) Removal of cooking oil from the fried food by centrifugation process

(76) Inventor: MOUAYED AL-ASAAD, North Shore (NZ)

Correspondence Address: MOUAYED AL-ASAAD, 27A Sunset Road, Glenfield, Auckland, 1310, NZ

(21) Appl. No.: 12/198,135

(22) Filed: Aug. 26, 2008

(30) Foreign Application Priority Data
Mar. 31, 2005 (NZ) NZ-539115
Feb. 23, 2007 (NZ) PCT/NZ2007/000039

(51) Int. Cl. A23P 1/00; A47J 37/12

(52) U.S. Cl. 426/417; 99/409

(57) ABSTRACT

The invention consists in a process for removing cooking oil from food. The cooked food is positioned in a rotatable basket and the basket is rotated whilst air flows over the food, to remove a substantial portion of the cooking oil from the body of the food. The food is then removed from the basket.

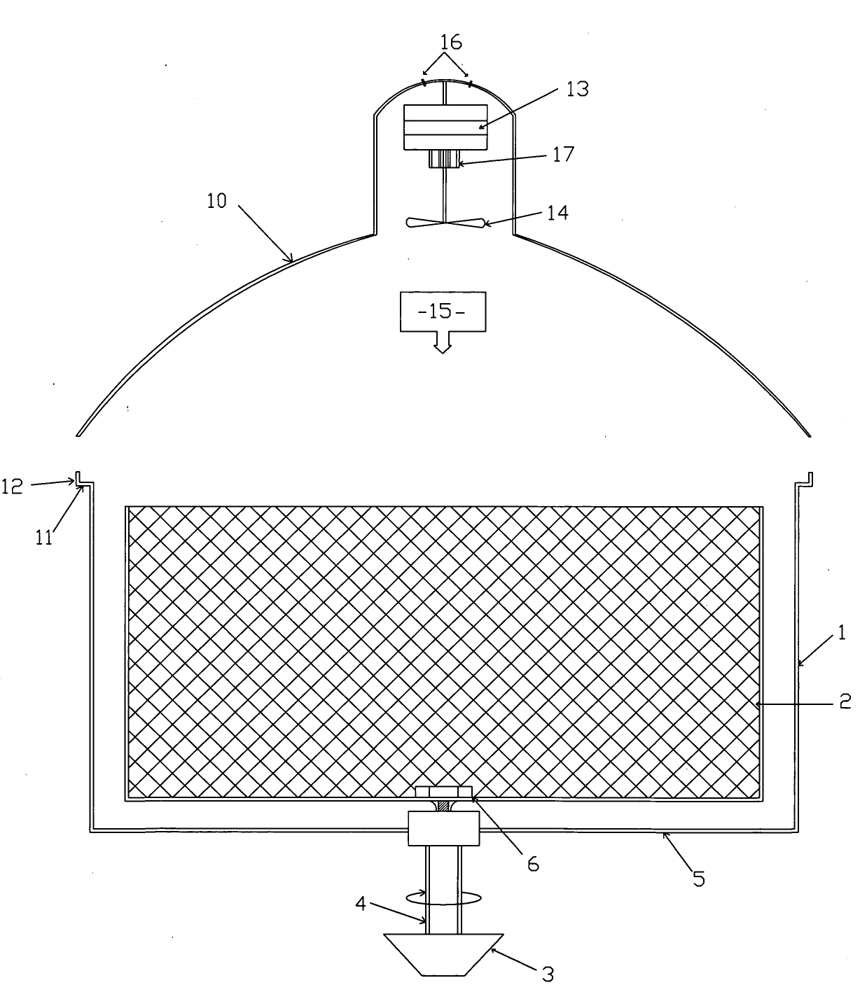

### TECHNICAL FIELD OF THE INVENTION

This invention relates to a process for removing cooking oil from food and/or apparatus therefore.

Around the world and including New Zealand people have become increasingly concerned about the health threats created by obesity and high fat intake when consuming food.

Fried foods such as French fries, fish and chips, fried chicken and frozen fried foods are high in fat in particular because of the process of frying food. No satisfactory method currently exists to remove cooking oil from fried foods subsequent to the cooling process in order to decrease the fat content of the fried food.

It is therefore an object of the present invention to provide a process for removing cooking oil from food and/or apparatus for removing cooking oil from food which will go at least someway towards meeting the foregoing requirements in a simple yet effective manner or which will at least provide the public with a useful choice.

Accordingly in one aspect of the invention consists in a process for removing cooking oil from food, comprising the steps of placing the cooked food into a rotatable basket; rotating the basket whilst causing air to flow over the food, to remove a substantial portion of the cooking oil from the food; and removing the food from the basket.

Preferably the step of causing air flow over the food comprises the step of causing a flow of heated air over the food.

Preferably the air is heated to a temperature of at least 70 degrees Celsius.

Preferably the basket is rotated at a speed between 700 and 1100 rpm.

Preferably the basket is spun for a period from 30 to 50 seconds.

In a further aspect, the invention consists in apparatus for removing cooking oil from food, comprising a rotatable basket, means to rotate the basket, and means operable to cause air to flow over the basket and any food therein in use.

Preferably the apparatus further includes a heater to heat air to be blown over the food.

Preferably the heater is capable of heating air to at least 70 degrees Celsius.

Preferably the apparatus further includes a pan able to receive the basket.

Preferably the apparatus further includes a lid for the pan and means to blow air and the heater are associated with the lid.

Preferably the pan includes a drain to allow removal of cooking oil from the pan.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawing which is a diagrammatic representation of apparatus for removing cooking oil from food and which is capable of effecting a process for removing cooking oil from food according to a preferred embodiment of the invention.

In the preferred form of the invention apparatus is provided for removing cooking oil from food which is cooked.

The apparatus comprises a pan 1 which is able to receive a basket 2 within the pan 1.

A motor 3 is provided which is able to rotate a driveshaft 4 which passes through the bottom 5 of the pan 1 through a suitable bearing 6 through which liquid or other free flowing material within the pan 1 in use will not readily pass. The basket 2 is attachable to the shaft 4 for example by providing a bolt 7 which is able to be screwed on the inside of the basket 2 and into a threaded depression in the end of the shaft 4.

The pan 1 has an exit aperture 8 at the bottom thereof so as to allow liquid such as cooking oil within the pan 1 to be drained therefrom and the outlet 8 preferably includes a closable valve 9.

Associated with the pan 1 is a lid 10 which is able to close the pan 1 for example, by being positionable on an out-turned web 11 which terminates in an upwardly extending flange 12.

It is desirable that air be blown over the food during use and to this end a motor 13 is provided able to drive a fan 14 to thereby blow air in the direction of arrow 15.

Air inlets such as inlets 16 are provided to the inlet side of the fan 14. A heater 17 is also desirably provided and the capacity of the heater 17 is desirably such that air moved by the fan 14 will reach a temperature of about 70 degrees Celsius at the time it reaches the basket 2 in use.

In use fried food or indeed any other material is taken from the fryer and is placed into the basket 2. The lid 10 is then placed over the pan 1, and the motors 3 and 13 operated so that the basket 2 is spun tending to cause cooking oil to be shed from the food within the basket 2 and at the same time heated air is blown over the food by the fan 14. A suitable speed of rotation of spinning basket 2 is between 700 and 1100 rpm. A suitable time period is 30 to 50 seconds although the timing will depend on factors such as the speed of rotation and quantity of food in basket 2. Speeds higher than 100 rpm may cause the food in basket 2 to disintegrate. The heated air particularly when in excess of about 70 degrees Celsius tends to assist the centrifuging process created by the spinning basket 2.

When sufficient of the oil has been removed the motors 3 and 13 can be stopped, the lid removed and the food removed from the basket.

It has been found that there is a substantial reduction in cooking oil remaining on the food when the process is used.

I claim:

1. A process for removing cooking oil from food, comprising the steps of placing the cooked food into a rotatable basket; rotating the basket whilst causing air to flow over the food, to remove a substantial portion of the cooking oil from the food; and removing the food from the basket.

2. A process as claimed in claim 1 wherein the step of causing air flow over the food comprises the step of causing a flow of heated air over the food.

3. A process as claimed in claim 2 wherein the air is heated to a temperature of at least 70 degrees Celsius.

4. A process as claimed in any one of claims 1 to 3 wherein the basket is rotated at a speed between 700 and 1100 rpm.

5. A process as claimed in any one of claims 1 to 4 wherein the basket is spun for a period from 30 to 50 seconds.

6. A process for removing cooking oil from food substantially as herein described with reference to the accompanying drawing.

7. Apparatus for removing cooking oil from food, comprising a rotatable basket, means operable to rotate the basket, and means to cause air to flow over the basket and any food therein in use.

8. Apparatus as claimed in claim 7 wherein the apparatus further includes a heater to heat air to be blown over the food.

9. Apparatus as claimed in claim 8 wherein the heater is capable of heating air to at least 70 degrees Celsius.

10. Apparatus as claimed in any one of claims 7 to 9 wherein the apparatus further includes a pan able to receive the basket.

11. Apparatus as claimed in claim 10 wherein the apparatus further includes a lid for the pan and means to blow air and the heater are associated with the lid.

12. Apparatus as claimed in either one of claims 10 and 11 wherein the pan includes a drain to allow removal of cooking oil from the pan.

13. Apparatus for removing cooking oil from food substantially as herein described with reference to the accompanying drawing.
